(19) United States
(12) Patent Application Publication
(10) Pub. No.: US 2016/0117094 A1
(43) Pub. Date: Apr. 28, 2016

(54) INPUT APPARATUS, VEHICLE COMPRISING OF THE SAME, AND CONTROL METHOD OF THE VEHICLE

(71) Applicant: Hyundai Motor Company, Seoul (KR)

(72) Inventor: Youngtak Jeon, Ansan (KR)

(21) Appl. No.: 14/711,055

(22) Filed: May 13, 2015

(30) Foreign Application Priority Data
Oct. 23, 2014 (KR) 10-2014-0143995

(51) Int. Cl. G06F 3/0488; G06F 3/0484; G06K 9/18

(52) U.S. Cl. CPC G06F 3/04883; G06K 9/18; G06F 3/04842

(57) ABSTRACT

Disclosed herein are an input apparatus, a vehicle having the same, and a control method of the vehicle. The input apparatus includes: a touch pad configured to receive input; an input coordinate system setting unit configured to set an input coordinate system at the touch pad so as to receive the input; a coordinate system converting unit configured to convert an input coordinate value of the input at the input coordinate system into a reference coordinate value of a preset reference coordinate system; a text recognition unit configured to recognize text based on the input by use of the converted reference coordinate value; and a display configured to display the recognized text and one or more text candidates based on the recognized text.

### CROSS-REFERENCE TO RELATED APPLICATION

This application claims priority to and the benefit of the Korean Patent Application No. 10-2014-0143995, filed on Oct. 23, 2014, in the Korean Intellectual Property Office, the entire disclosure of which is incorporated herein by reference.

### BACKGROUND

1. Technical Field

Embodiments of the present disclosure relate to an input apparatus into which text is input, a vehicle having the same, and a control method of the vehicle.

2. Description of the Related Art

Conventional vehicles can include a cluster configured to display driving functions and vehicular information, such as speed of the vehicle, number of engine rotations of the vehicle, amount of fuel, and a coolant. In addition, other than the basic driving functions, vehicles can include additional functions provided for enhancing the convenience of a user, such as audio functions, video functions, navigation functions, air conditioner controls, and lighting controls.

An input method (e.g., by use of a touch pad, buttons and dials, a touch screen, etc.) may be used as to manipulate the functions of the vehicle as such. With respect to the input method by use of the touch pad, in particular, the method as such is provided to input commands configured to manipulate functions of the vehicle by use of the touch pad, which is generally mounted in a fixed direction at the upper portion of the center console. Thus, the use of the touch pad may be constrained according to the position of a user, and in certain cases, the recognition of such may be limited.

### SUMMARY

It is an aspect of the present disclosure to provide an input apparatus configured to provide text candidates being input, as well as additional text candidates, and a vehicle having the same. It is another aspect of the present disclosure to provide an input apparatus capable of setting a virtual input coordinate system on a touch pad, and a vehicle having the same. Additional aspects of the disclosure will be explicitly and/or implicitly set forth in part in the description which follows, or may be learned by practice of the disclosure.

In accordance with embodiments of the present disclosure, an input apparatus includes: a touch pad configured to receive input; an input coordinate system setting unit configured to set an input coordinate system at the touch pad so as to receive the input; a coordinate system converting unit configured to convert an input coordinate value of the input at the input coordinate system into a reference coordinate value of a preset reference coordinate system; a text recognition unit configured to recognize text based on the input by use of the converted reference coordinate value; and a display configured to display the recognized text and one or more text candidates based on the recognized text.

In addition, the input coordinate system may be varied according to settings of a user.

In addition, rotation angles of the input coordinate system may be varied with respect to the reference coordinate system according to settings of a user.

In addition, the input coordinate system is preset according to an environment of a vehicle.

In addition, in a case of a left hand drive (LHD) vehicle, the input coordinate system is set while rotated toward a clockwise direction with respect to the reference coordinate system, and in a case of a right hand drive(RHD) vehicle, the input coordinate system is set while rotated toward a counter-clockwise direction with respect to the reference coordinate system.

In addition, an input coordinate system display unit configured to display rotation angles of the input coordinate system with respect to the reference coordinate system is further included.

In addition, the one or more text candidates are selected by reflecting rotation angles of the input coordinate system with respect to the reference coordinate system.

In addition, the display is further configured to display additional text candidates based on the recognized text, and the additional text candidates are selected using a technique other than the reflecting of rotation angles of the input coordinate system with respect to the reference coordinate system.

Furthermore, in accordance with embodiments of the present disclosure, a vehicle includes: a touch pad configured to receive input; an input coordinate system setting unit configured to set a input coordinate system at the touch pad so as to receive the input; a coordinate system converting unit configured to convert an input coordinate value of the input at the input coordinate system into a reference coordinate value of a preset reference coordinate system; a text recognition unit configured to recognize text based on the input by use of the converted reference coordinate value; and a display configured to display the recognized text and one or more text candidates based on the recognized text.

In addition, the input coordinate system may be varied according to settings of a user.

In addition, rotation angles of the input coordinate system may be varied with respect to the reference coordinate system according to settings of a user.

In addition, the input coordinate system is predetermined according to an environment of a vehicle.

In addition, in a case of a left hand drive(LHD) vehicle, the input coordinate system is set while rotated toward a clockwise direction with respect to the reference coordinate system, and in a case of a right hand drive(RHD) vehicle, the input coordinate system is set while rotated toward a counter-clockwise direction with respect to the reference coordinate system.

In addition, an input coordinate system display unit configured to display rotation angles of the input coordinate system with respect to the reference coordinate system is further included.

In addition, the one or more text candidates are selected by reflecting rotation angles of the input coordinate system with respect to the reference coordinate system.

In addition, the display is further configured to display additional text candidates based on the recognized text, and the additional text candidates are selected using a technique other than the reflecting of rotation angles of the input coordinate system with respect to the reference coordinate system.

Furthermore, in accordance with embodiments of the present disclosure, a control method of a vehicle includes: receiving input at an input coordinate system that is set at a touch pad; converting an input coordinate value of the input at the input coordinate system into a reference coordinate value of a preset reference coordinate system; recognizing text based on the input by use of the converted reference coordinate value; and displaying the recognized text and one or more text candidates based on the recognized text.

In addition, controlling a setting of the input coordinate system at the touch pad may be further included.

In addition, the input coordinate system may be varied according to settings of a user.

In addition, the input coordinate system may be preset according to an environment of a vehicle.

In addition, the one or more text candidates are selected by reflecting rotation angles of the input coordinate system with respect to the reference coordinate system.

In addition, displaying additional text candidates is further included; and the additional text candidates may be selected using a technique other than the reflecting rotation angles of the input coordinate system with respect to the reference coordinate system.

Accordingly, user convenience may be enhanced by providing one or more text candidates based on the recognized text, as well as additional text candidates, in response to input at an input apparatus. In addition, the usability of the input apparatus may be improved by providing a user with a direction of writing suitable for the environment of a vehicle. In addition, a user may be able to input texts at a predetermined input angle by changing the settings of an input coordinate system.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating an exterior appearance of a vehicle in accordance with embodiments of the present disclosure.

FIG. 2 is a drawing showing an inside structure of the vehicle in accordance with embodiments of the present disclosure.

FIG. 3 is a drawing showing an input apparatus in accordance with embodiments of the present disclosure.

FIG. 4 is a drawing showing a touch pad in accordance with embodiments of the present disclosure.

FIG. 5 is a block diagram showing a structure of the input apparatus in accordance with embodiments of the present disclosure.

FIG. 6 and FIG. 7 are drawings illustrating examples of texts being input at the touch pad by a user.

FIG. 8 and FIG. 9 are drawings illustrating images of coordinate values being input at input coordinate systems.

FIG. 10 is a drawing illustrating an image of an input coordinate on the input coordinate system converted into a reference coordinate on the reference coordinate system.

FIG. 11 and FIG. 13 are drawings illustrating examples of displaying a display.

FIG. 14 is a drawing showing an input apparatus in accordance with embodiments of the present disclosure.

FIG. 15 is a drawing showing a touch pad in accordance with embodiments of the present disclosure.

FIG. 16 is a drawing illustrating an example of a structure of a coordinate system display unit.

FIG. 17 is a block diagram showing a structure of the input apparatus in accordance with embodiments of the present disclosure.

FIG. 18 is a drawing showing a flow chart of a vehicle control method in accordance with embodiments of the present disclosure.

FIG. 19 is a drawing showing a flow chart of a vehicle control method in accordance with embodiments of the present disclosure.

### DETAILED DESCRIPTION

Reference will now be made in detail to the embodiments of the present disclosure, examples of which are illustrated in the accompanying drawings, wherein like reference numerals refer to like elements throughout.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

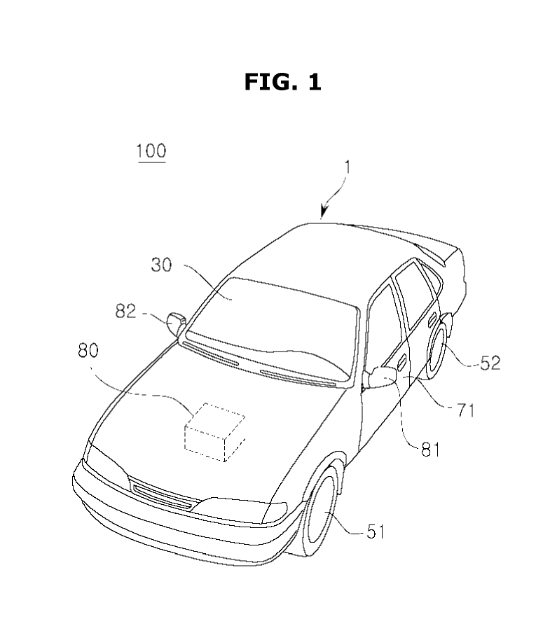

FIG. 1 is a perspective view illustrating an exterior appearance of a vehicle 100 in accordance with embodiments of the present disclosure.

Referring to FIG. 1, the vehicle includes a body 1 forming an exterior appearance of the vehicle 100, a front glass 30 providing a front view of the vehicle 100 to a driver at an inside the vehicle 100, vehicular wheels 51 and 52 to move the vehicle 100, a driving apparatus 60 to rotate the vehicular wheels 51 and 52, a door 71 to open/close an inside the vehicle 100 from an outside, and side mirrors 81 and 82 to provide a rear view of the vehicle 100 to a driver. The front glass 30 (i.e., windshield) is provided at an upper side of a front of the body 1 such that a driver of the vehicle 100 may be able to obtain visual information at the front of the vehicle 100.

The vehicular wheels 51 and 52 include front wheels 51 provided at a front of the vehicle 100 and rear wheels 52 provided at a rear of the vehicle 100, and the driving apparatus 100 may be able to deliver rotational force to the front wheels 51 or the rear wheels 52 such that the body 1 may be moved to a front direction or a rear direction. The driving apparatus 60 as such may employ an engine to generate rotational force by combusting fossil fuel or a motor to generate rotational force while provided with a power from a capacitor (not shown). The door 71 is rotatively provided at a left side and a right side of the body 1 such that a driver may board into an inside the vehicle 100 at the time of when the door 71 is open, and at the time of when the door 71 is closed, the door 71 may be able to close an inside the vehicle 100 from an outside.

A window 72 through which an outside may be seen or an inside may be seen may be installed at the door 71, and in accordance with embodiments of the present disclosure, the window 72 is provided as to be seen from one side, and may also be provided to be open/closed. The side mirrors 81 and 82 include a left side mirror 81 provided at a left side of the body 1 and a right side mirror 82 provided at a right side of the body 1, and is provided such that a driver at an inside the vehicle 100 may be able to obtain visual information of sides and a rear of the vehicle 100.

Other than the above, the vehicle 100 may include a front camera to obtain visual information of a front, as well as a left side camera and a right side camera to secure wide views, and a detecting apparatus such as a proximity sensor to sense a rear obstacle or a rain sensor to detect the presence of precipitation or the amount of precipitation may be included. The proximity sensor may employ a method of radiating detecting signals at sides or rear or the vehicle 100 and receiving reflective signals being reflected from an obstacle. The proximity sensor is able to detect the presence of an obstacle on the basis of waveforms of the received reflective signals, and may be able to detect the position of the obstacle. The rain sensor may be able to collect the information with respect to the amount of precipitation that is fallen on the front glass 30. As an example of the rain sensor, an optical sensor and a magnetic sensor may be included, but is not limited hereto.

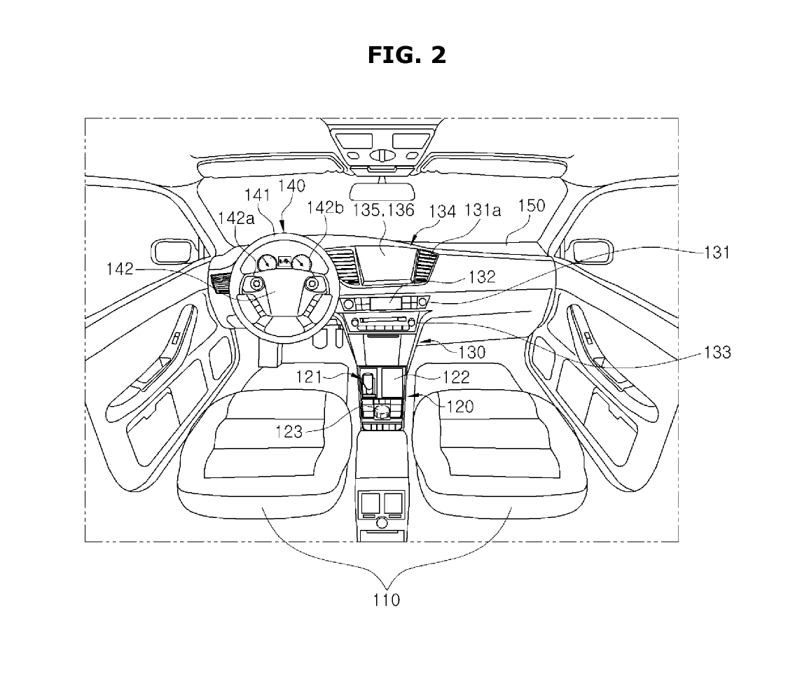

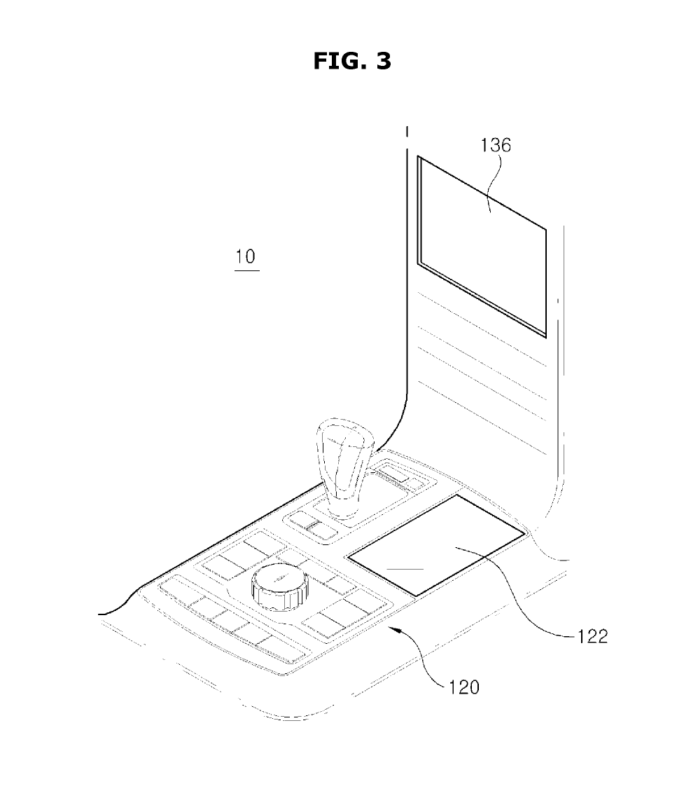

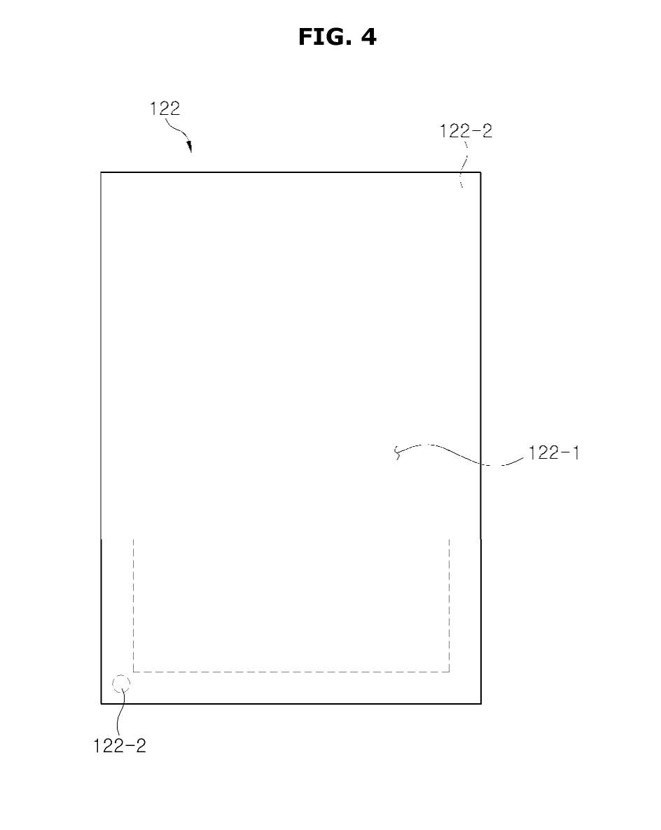

FIG. 2 is a drawing showing an inside structure of the vehicle 100 in accordance with embodiments of the present disclosure, FIG. 3 is a drawing showing an input apparatus 10 in accordance with embodiments of the present disclosure, and FIG. 4 is a drawing showing a touch pad 122 in accordance with embodiments of the present disclosure.

Referring to FIG. 2, the vehicle 100 includes a seat 110 at which a driver and passengers board on, and a dashboard 150 at which a gear box 120, a center fascia 130, and a steering wheel 140 are provided. A speed changing lever 121 to change the speed of the vehicle 100 and the touch pad 122 to control the execution of the function of the vehicle 100 may be installed at the gear box 120. Optionally, a dial manipulating unit 123 may be selectively installed.

An air conditioning apparatus 131, a clock 132, an audio apparatus 133, and an audio-video-navigation (AVN) apparatus 134 may be installed at the center fascia 130. The air conditioning apparatus 131 is configured to comfortably maintain an inside the vehicle 100 by adjusting the temperature, humidity, purity, and flow of the air at the inside the vehicle 100. The air conditioning apparatus 131 may include at least one outlet hole 131a installed at the center fascia 130 and configured to outlet air. Buttons or dials configured to control the air conditioning apparatus 131 may be installed at the center fascia 130. A user such as a driver may be able to control the air conditioning apparatus 131 by use of the buttons disposed at the center fascia 130.

The clock 132 may be provided at the surroundings of the buttons or the dials provided to control the air conditioning apparatus 131. The audio apparatus 133 includes a manipulating panel at which a plurality of buttons configured to execute functions of the audio apparatus 133 is provided. The audio apparatus may provide a radio mode configured to provide radio functions and a media mode to replay audio files of various storage mediums in which the audio files are stored. The AVN apparatus 134 may be formed while built into an inside the center fascia 130 of the vehicle 100. The AVN apparatus 134 is an apparatus configured to integrally execute audio functions, video functions, and navigation functions according to the control of a user. The AVN apparatus 134 may include an input unit 135 configured to receive use commands with respect to the AVN apparatus 134, and a display 136 to display screens related to the audio functions, screens related to the video functions, and screens related to the navigation functions.

The steering wheel 140 is an apparatus configured to steer the driving of the vehicle 100, and may include a rim 141 to be grabbed by a driver, and a spoke 142 connected to a steering apparatus of the vehicle 100 and configured to connect the rim 141 and a hub of a rotational axis provided for steering. According embodiments of the present disclosure, manipulative apparatus 142a and 142b configured to control various apparatuses, such as the audio apparatus as one example may be formed at the spoke 142. In addition, a glove box may be further included at the dashboard 150 provided as to store various instrument panels configured to display speed, number of engine rotations, and amount of fuel of the vehicle 100, as well as various material.

Referring to FIG. 3 and FIG. 4, the input apparatus 10 in accordance with embodiments of the present disclosure will be described in detail. FIG. 3 is a drawing showing an input apparatus 10 in accordance with embodiments of the present disclosure, and FIG. 4 is a drawing showing the touch pad 122 in accordance with embodiments of the present disclosure.

Referring to FIG. 3 and FIG. 4, the input apparatus 10 in accordance with embodiments of the present disclosure may include the touch pad 122 provided to receive input (e.g., text), and the display 136 to display the text being input at the input coordinate system, as well as the text candidates based on the texts. The touch pad 122 may be installed at the gear box 120 at an inside the vehicle 100. The gear box 120 is general may be installed in between a driver's seat and a passenger's seat at an inside the vehicle 100, and the descriptions that overlap with respect to the previous descriptions related to the gear box 120 will be omitted. The touch pad 122 may receive input via touch gestures of a user, and the user can provide the input in order to enter text. The touch pad 122 may be implemented in various methods of a touch panel, which are already published, including a decompression type or an electrostatic type. In accordance with embodiments of the present disclosure, in a case when the touch pad 122 is provided in the form of the decompression type, the data of the point being physically decompressed by use of a finger or a tip of a pen may be obtained, and the data as such may be provided to a text recognition process, which is to be described later.

The touch pad 122 may be provided with a touch domain 122-1. The touch domain 122-1 is a domain provided to be input with touch signals of a user, and may be a virtual domain formed at an upper surface of the touch pad 122. The touch pad 122 may include an input coordinate system setting unit 122-2 at one domain. The input coordinate system setting unit 122-2 may be able to set a virtual input coordinate system on the touch pad 122 as to receive texts. As illustrated on FIG. 4, the input coordinate system setting unit 122-2 may be provided at a particular domain of the touch pad 122. In a case when the input coordinate system setting unit 122-2 is provided as illustrated on FIG. 4, the input coordinate system may be set by use of a method of touching the input coordinate system setting unit 122-2.

The display 136, while provided at a central portion of an upper portion of the center fascia 130, may be able to display information related to texts being input at the touch pad 122. In accordance with embodiments of the present disclosure, the display 136 may employ the display 136 of the AVN apparatus 134. Hereinafter, a case of the information related to text being displayed at the display 136 of the AVN apparatus 134 will be described as an example.

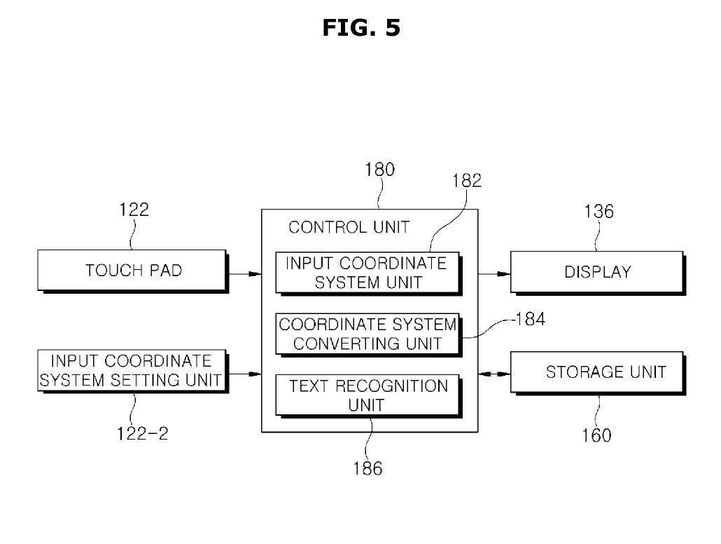

FIG. 5 is a block diagram showing a structure of the input apparatus 10 in accordance with embodiments of the present disclosure.

Referring to FIG. 5, the input apparatus 10 in accordance with embodiments of the present disclosure may include the touch pad 122, the input coordinate system setting unit 122-2, the display 136, a storage unit 160, and a control unit 180. The touch pad 122 may be provided with the touch domain 122-1. The touch domain 122-1 is a domain provided to be input with touch signals of a user as to input texts, and may be a virtual domain formed at an upper surface of the touch pad 122. The touch domain 122-1 may be defined as an input coordinate system. The input coordinate system may be provided with a direction by use of a method of adjusting rotational angles with respect to a preset reference coordinate system. That is, a suitable direction of writing may be provided to a user by adjusting the direction of the input coordinate system with respect to the reference coordinate system.

The touch domain 122-1 may be a preset domain according to the environment of a vehicle. Here, the environment of a vehicle may be a concept having the environment of a left hand drive (LHD) vehicle or the environment of a right hand drive (RHD) vehicle. In accordance with embodiments of the present disclosure, the touch domain 122-1 in the environment of the LHD vehicle may be set while being rotated toward a clockwise direction of the touch pad 122. In the contrary, the touch domain 122-1 in the environment of the RHD vehicle may be set while being rotated toward a counter-clockwise direction of the touch pad 122.

The input coordinate system setting unit 122-2 may set a virtual input coordinate system as to be input with texts. A user may set the new touch domain 122-1 through the input coordinate system setting unit 122-2, or change setting conditions of the touch domain 122-1 that is previously set. The input coordinate system setting unit 122-2 may be provided at a portion of a domain of the touch pad 122 in the shape of being able to be touched. A user may be able to set the input coordinate system which is rotated by about 90° in a clockwise direction by touching the input coordinate system setting unit 122-2 provided at an upper end of the right side of the touch pad 122, or may be able to set the input coordinate system which is rotated by about 90° in a counter-clockwise direction by touching the input coordinate system setting unit 122-2 provided at a lower end of the left side of the touch pad 122.

In accordance with embodiments of the present disclosure, the input coordinate system provided at the lower end of the left side of the touch pad 122 is set to be rotated along a clockwise direction in several steps by touching the input coordinate system setting unit 122-2 provided at the upper end of the right side of the touch pad 122 several times, or the input coordinate system provided at the lower end of the left side of the touch pad 122 is set to be rotated along a counter-clockwise direction in several steps by touching the input coordinate system setting unit 122-2 provided at the lower end of the left side of the touch pad 122 several times. In addition, the rotational angle of the input coordinate system may be adjusted by providing the plurality of input coordinate system setting unit 122, or the setting of the input coordinate system may be changed by providing and disposing physical buttons at the surroundings of the touch pad 122 or through rotational manipulation of the dial manipulating unit 123 provided at the gear box 120.

The display 136 may be able to display the texts being input at the input coordinate system and the text candidates. Here the text candidates may include the texts that are selected by considering rotational angles of the input coordinate system with respect to the preset reference coordinate system. In accordance with embodiments of the present disclosure, the display 136 may also display additional text candidates of the texts being input at the input coordinate system. The additional text candidates of the texts may include the texts that are selected without reflecting rotational angles of the input coordinate system with respect to the preset reference coordinate system.

The storage unit 160 may be able to store various data, programs, or applications configured to drive and control the input apparatus 10. According to one example, the storage unit 160 may be able to store the programs provided to recognize the texts being input at the touch pad 122 by a user, applications exclusively provided for the first time by manufacturers, or applications publicly downloadable from an outside. The storage unit 160 maybe able to store the data with respect to the preset input coordinate system or the information with respect to the input coordinate system that is newly set by a user. In addition, the storage unit 160 may store the information with respect to the texts that may be input at the touch pad 122, the text candidates, or the additional text candidates of the texts. The storage unit 160 as such may include at least one of the storage mediums from a flash memory, a hard disc, a card-type memory (for example, a SD memory or a XD memory), a RAM (Random Access Memory), a SRAM (Static Random Access Memory), a ROM (Read-Only Memory), an EEPROM (Electrically Erasable Programmable Read-Only Memory), or PROM (Programmable Read-Only Memory). However, the above is not limited hereto, and may include the change within a range that a typical technician may employ.

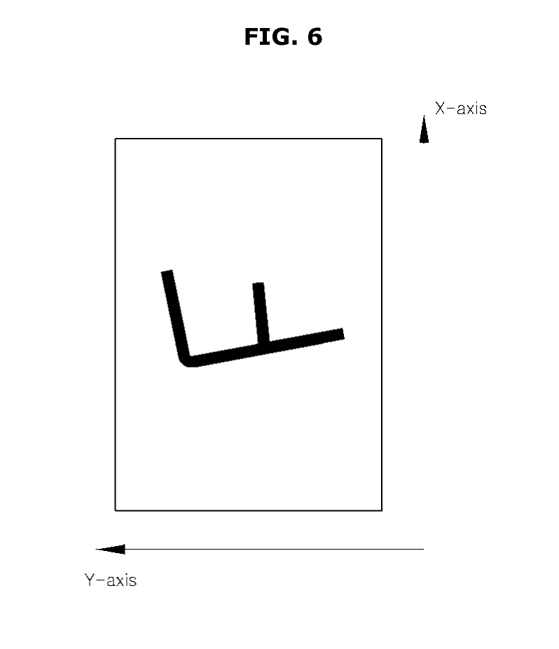

The control unit 180 is provided to control an overall motion of the input apparatus 10 as well as flows of signals in between structural elements at an inside the input apparatus 10, and may be able to perform functions to process data. The control unit 180 may be able to execute various applications as well as an operating system (OS) stored at the storage unit 160 in a case when the input of a user of the preset conditions are satisfied. The control unit 180 as such may include an input coordinate system input unit 182 provided to be input with coordinate values of the input coordinate system transmitted from the touch pad 122, a coordinate system converting unit 184 to convert the input coordinates of the input coordinate system into reference coordinates on the reference coordinate system, and a text recognition unit 186 to recognize texts by processing the converted reference coordinates. The principles of motions of the input coordinate system input unit 182, the coordinate system converting unit 184, and the text recognition unit 186 will be described in detail by referring to FIG. 6 to FIG. 10.

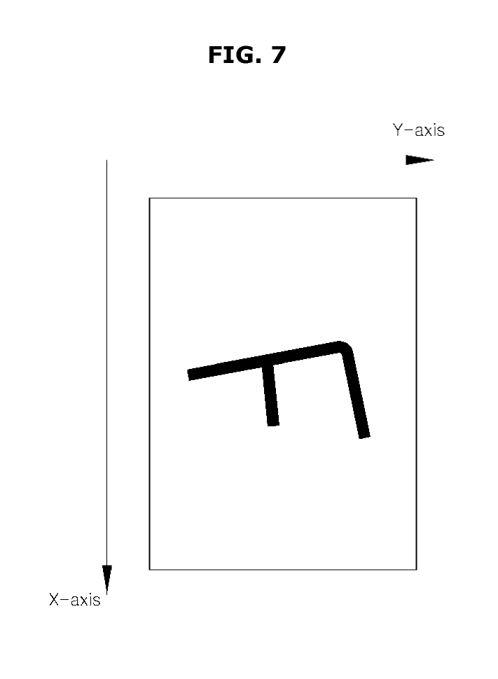

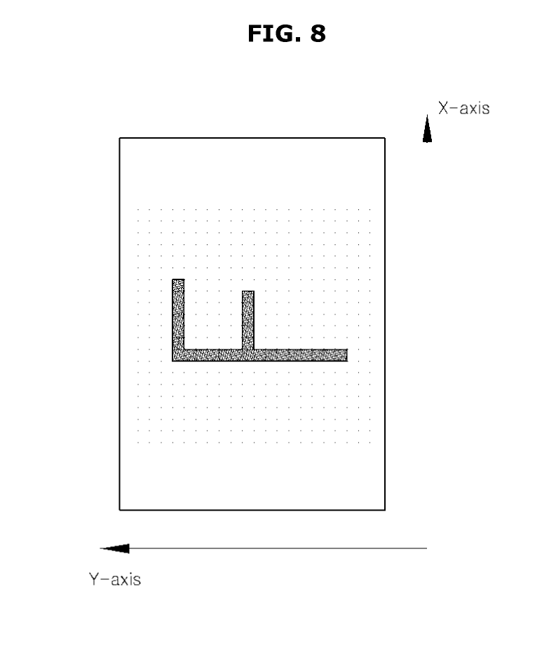

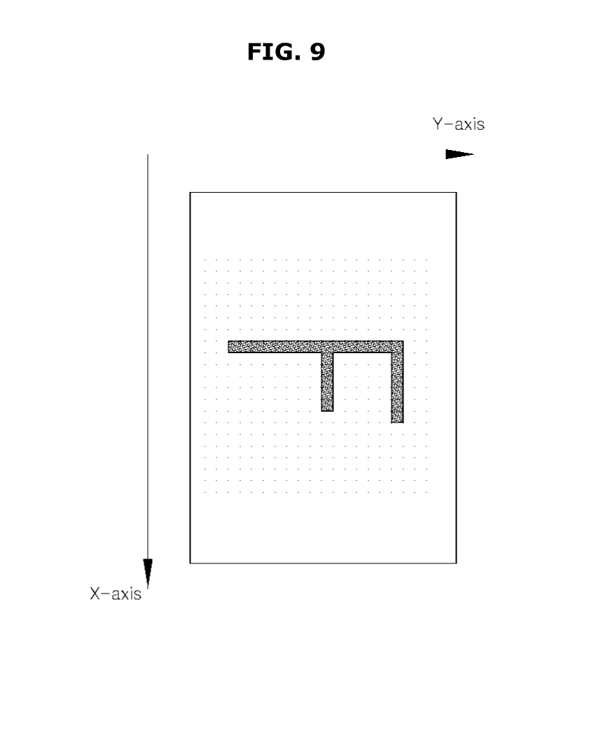

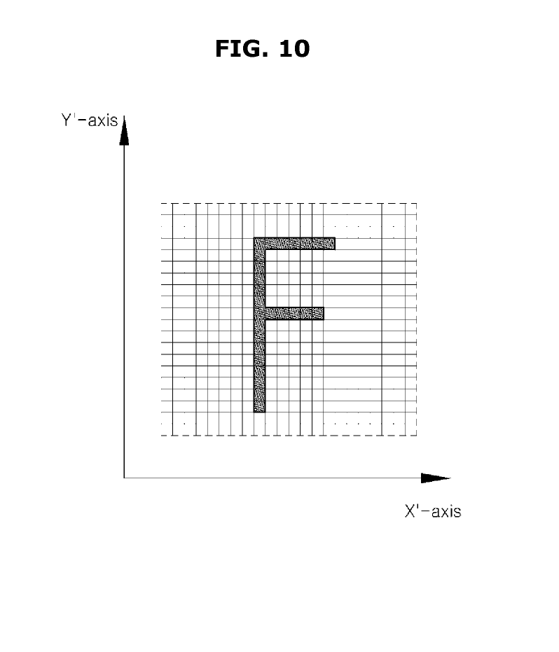

FIG. 6 and FIG. 7 are drawings illustrating examples of texts being input at the touch pad by a user, FIG. 8 and FIG. 9 are drawings illustrating images of coordinate values being input at input coordinate systems, and FIG. 10 is a drawing illustrating an image of an input coordinate on the input coordinate system converted into a reference coordinate on the reference coordinate system. On FIG. 10, the reference coordinate system is a coordinate system provided as a reference of the input coordinate system, and hereinafter, with respect to the reference coordinate system, the direction from the right side of the vehicle 100 from the left side of the vehicle 100 may be defined as an x-axis, and the direction from the left side of the vehicle 100 from the right side of the vehicle 100 may be defined as a y-axis.

FIG. 6 is a drawing illustrating a case of texts being input by a user at the input coordinate system that is rotated 90° toward a counter-clockwise direction with respect to the reference coordinate system. With respect to the input coordinate system illustrated on FIG. 6, the direction toward the front of the vehicle 100 from the rear of the vehicle 100 may be defined as an x-axis, and the direction toward the left side of the vehicle 100 from the right of the vehicle 100 may be defined as a y-axis. In a case when the input coordinate system is provided in an identical direction as on FIG. 6, a user boarded on a passenger's seat of the LHD vehicle 100 of on a driver's seat of the RHD vehicle 100 may be able to input texts by twisting the body of the user toward a left side.

Meanwhile, FIG. 7 is a drawing illustrating a case of texts being input by a user at the input coordinate system that is rotated 90° toward a clockwise direction with respect to the reference coordinate system. With respect to the input coordinate system illustrated on FIG. 7, the direction toward the rear of the vehicle 100 from the front of the vehicle 100 may be defined as an x-axis, and the direction toward the right side of the vehicle 100 from the left of the vehicle 100 may be defined as a y-axis. In a case when the input coordinate system is provided in an identical direction as on FIG. 7, a user boarded on a passenger's seat of the LHD vehicle 100 of on a driver's seat of the RHD vehicle 100 may be able to input texts by twisting the body of the user toward a right side.

As illustrated on FIG. 6 and FIG. 7, a user may be able to input texts by use of the input coordinate system rotated by a certain angle with respect to the reference coordinate system. That is, the input apparatus 10 in accordance with embodiments of the present disclosure may be able to improve usability of the input apparatus 10 by providing a user with the input coordinate system that is rotated by a certain angle.

For example, when a user inputs a letter ‘F’ at the input coordinate system on FIG. 6 or FIG. 7, the coordinate value of the text may be transmitted to the input coordinate system input unit 182. When the input coordinate value of the text is transmitted to the input coordinate system input unit 182, the input coordinate values may be input at the input coordinate system. FIG. 8 and FIG. 9 are drawings illustrating images of the coordinate values are input at the input coordinate system, and in detail, FIG. 8 is a drawing illustrating an image of the coordinate value is input when a text is input by a user at the input coordinate system as in a case illustrated on FIG. 6, and FIG. 9 is a drawing illustrating an image of the coordinate value is input when a text is input by a user at the input coordinate system as in a case illustrated on FIG. 7.

When input coordinate values are input at the input coordinate system, the coordinate system converting unit 184 may be able to convert the input coordinate values into coordinate values at the reference coordinate system that is preset. The information related to rotational angle of the input coordinate system with respect to the preset input coordinate system, as well as the information related to movements, may be stored at the storage unit 160. The coordinate system converting unit 184 may be able to convert the input coordinate values at the input coordinate system into reference coordinate values at the reference coordinate system by use of the information as such stored at the storage unit 160. Referring to the illustration on FIG. 10, when the input coordinate at the input coordinate system illustrated on FIG. 8 and FIG. 9 is converted into a reference coordinate at the reference coordinate system, the input coordinate is converted into the shape of a letter ‘F’ without being inclined.

Next, the text recognition unit 186 may be able to recognize texts by use of the information related to a reference coordinate at a reference coordinate system. That is, in the present embodiments, a user is recognized that the alphabet letter “F’ is input by the user by use of the information related to the reference coordinate at the reference coordinate system. When the input text is recognized as the alphabet letter ‘F’, the display may be able to display the alphabet letter ‘F’. In addition, the display 136 may be able to display the text candidates of the alphabet letter ‘F’ as well. The text candidates of the alphabet letter ‘F’ may be the texts selected by reflecting the rotational angle of the input coordinate system with respect to the preset coordinate system. In the present embodiments, the letter ‘F’ is recognized by reflecting the rotational angle of the input coordinate system with respect to the preset reference coordinate system, and thus similar letters such as the alphabet letter ‘E’ or ‘H’ may be displayed as the text candidates, or the Korean letter ‘ [symbol] ’ may be displayed as the text candidate.

In accordance with embodiments of the present disclosure, the display 136 may be able to display additional text candidates of the alphabet letter ‘F’. The additional text candidates may be the texts selected using a different technique, i.e., without reflecting the rotational angle of the input coordinate system with respect to the preset coordinate system. For example, as shown on FIG. 6 or FIG. 7, in a case when the alphabet letter ‘F’ is input while rotated toward a clockwise direction or a counter-clockwise direction with respect to the reference coordinate system, similar texts as to the rotated alphabet letter ‘F’ may be selected as the additional text candidates. According to one example, as for the additional text candidates of the alphabet letter ‘F’, the Korean letters ‘ [symbol] ’ or ‘ [symbol] ’ may be displayed. The data with respect to the text candidates and the additional text candidates with respect to each letter may be already stored at the storage unit 160, and the data with respect to the text candidates and the additional text candidates that are stored at the storage unit 160 may be periodically updated according to needs.

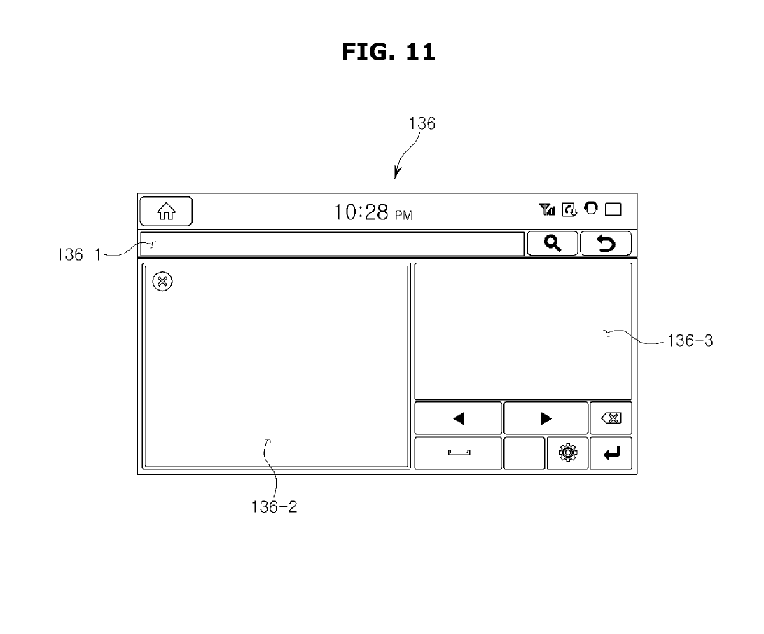

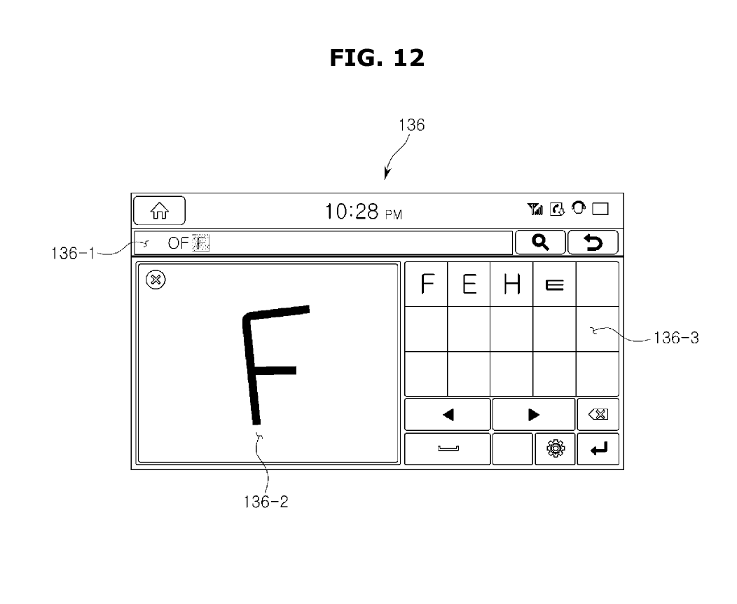

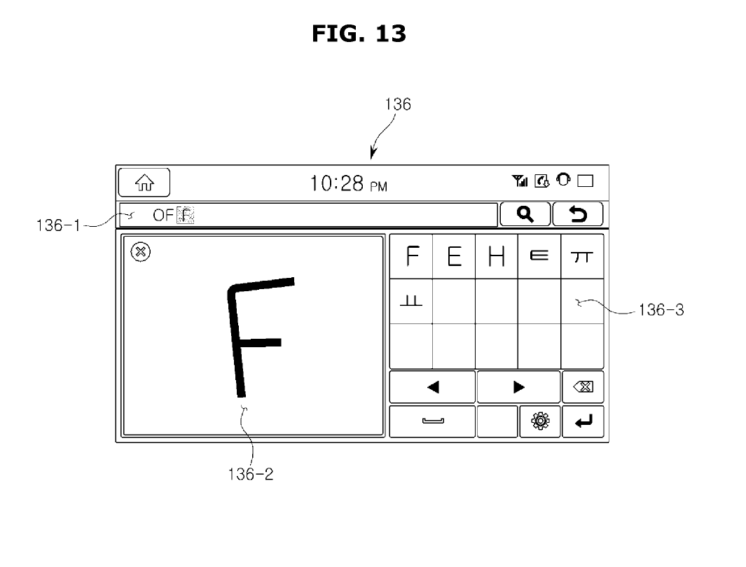

FIGS. 11-13 are drawings illustrating examples of displaying the display 136. In particular, FIG. 11 is a drawing illustrating a preparation screen as to be provided with texts from a user, FIG. 12 is a drawing illustrating a screen displaying the text being input by a user and text candidates of the text, and FIG. 13 is a drawing illustrating a screen showing the text candidates and additional text candidates of the text which is input by a user.

Referring to FIG. 11, with respect to the display 136, a first domain 136-1 at which the recognized text is displayed may be implemented at an upper end of the display 136 while a second domain 136-2 configured to display text being input on a real time basis may be implemented at a lower end of a left side of the display 136, as a third domain 136-3 configured to display text candidates or additional text candidates of the text may be implemented at a lower end of a right side of the display 136. On FIG. 11, one example of a screen of the display 136 is illustrated, and the examples of structuring the screen of the display 136 are not limited hereto.

When a text is input by a user, the touch drag detected at the touch pad 122 may be directly displayed at the second domain 136-2 implemented at the lower end of the left side of the display 136. On FIG. 12 and FIG. 13, an example of a user inputting the alphabet letter ‘F’ is illustrated. When the text input at the touch pad 122 is recognized as the alphabet letter ‘F’, the ‘F’ may be displayed at the first domain 136-1. In addition, as illustrated on FIG. 12, the alphabets ‘E’ or ‘H’ which are similar texts as to the ‘F’ may be displayed at the third domain 136-3 as the text candidates of the ‘F’, or the Korean letter ‘ [symbol] ’ may be displayed as well. As illustrated on FIG. 13, the Korean letters ‘ [symbol] ’ or ‘ [symbol] ’ may also be displayed along as the additional text candidates of the ‘F’.

Next, an input apparatus 10a in accordance with embodiments of the present disclosure will be described. The vehicle 100 may include the input apparatus 10a in accordance with embodiments of the present disclosure, and hereinafter, the descriptions will be provided while having the input apparatus 10a as a center of the descriptions.

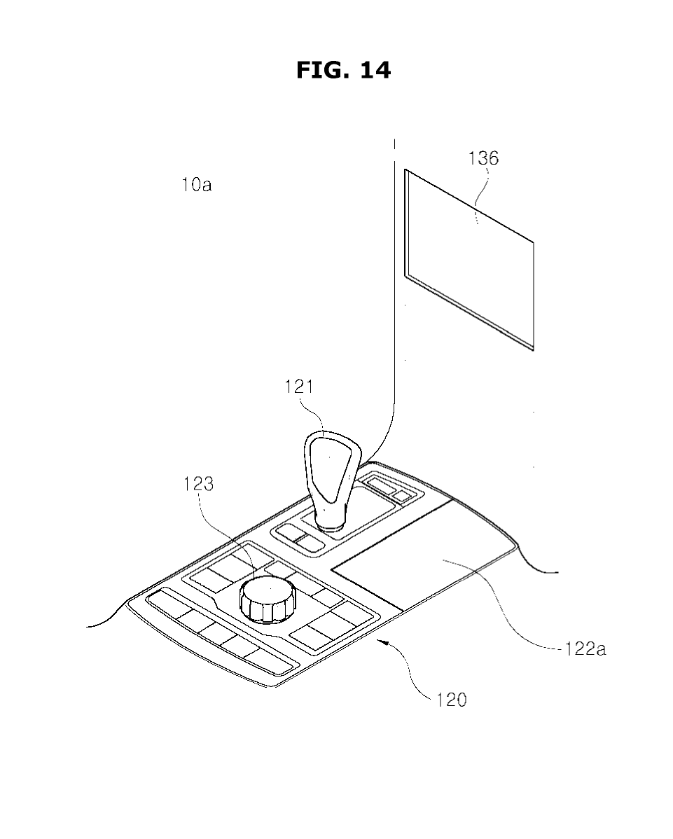

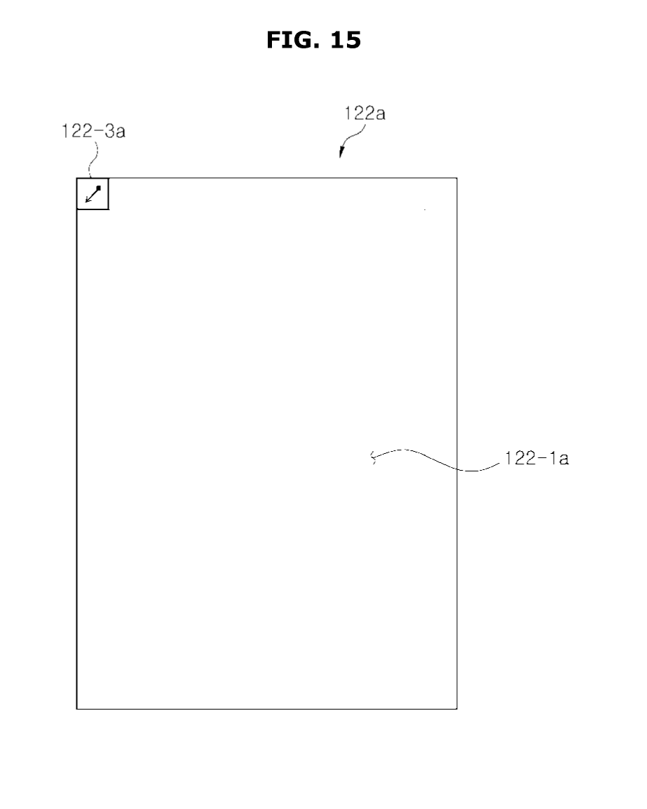

FIG. 14 is a drawing showing the input apparatus 10a in accordance with embodiments of the present disclosure, FIG. 15 is a drawing showing a touch pad 122a in accordance with embodiments of the present disclosure.

Referring to FIG. 14 and FIG. 15, with respect to the input apparatus 10a in accordance with embodiments of the present disclosure, a coordinate system display unit 122-3a configured to display rotational direction of the input coordinate system may be installed at the surroundings of the touch pad 122a at which a text is input.

The Input coordinate system defining a touch domain 122-1a at the touch pad 122a may be provided in the shape of being inclined such that a user may be able to easily input texts. The touch pad 122a in accordance with the present embodiments may be different with respect to the touch pad 122 of FIG. 4 as the touch pad 122a is provided with the coordinate system display unit 122-3a such that a user may be able to recognize clearly the direction of text being input.

As illustrated on FIG. 15, the coordinate system display unit 122-3a may be provided at a particular domain of the touch pad 122a. Meanwhile, although not illustrated, the coordinate system display unit 122-3a may be provided at the surroundings of the touch pad 122, or may also be provided while assigned with one domain of the display 136.

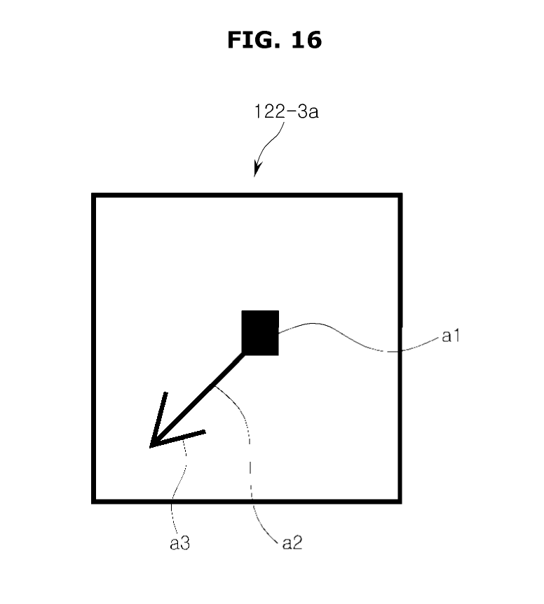

FIG. 16 is a drawing illustrating an example of a structure of the coordinate system display unit 122-3a.

Referring to FIG. 16, the coordinate system display unit 122-3a in accordance with embodiments of the present disclosure includes a dot a1, a line a2, and an arrow a3. The dot a1 may be provided at a central portion of the coordinate system display unit 122-3a, and the arrow a3 may be rotated while having the dot 1a as a center. The dot a1, by use of variable shape thereof, may be able to show the information related to the shape of the touch domain 122-1a. According to one example, the dot al may be varied in the form of a rectangle or a circle, as the input coordinate system may be provided in the shape of a rectangle or a circle.

The line a2 may be provided in a method of connecting the dot a1 and the arrow a3. The line a2 may be able to show the information related to the size of the coordinate system display unit 122-3a by use of length or thickness of the line a2. According to one example, in a case when the line a2 is provided thicker or longer, the such may define a case that the coordinate system display unit 122-3a is provided in a wide manner, and in a case when the line a2 is provided thinner or shorter, the such may define a case that the coordinate system display unit 122-3a is provided in a narrow manner.

The arrow a3 may be able to show the information related to the direction of the input coordinate system. That is, the information related to rotational angles of the input coordinate system with respect to the reference coordinate system may be included. As illustrated on FIG. 16, in a case when the arrow a3 is provided to indicate a lower end of a left side, the above may define the input coordinate system is provided while rotated by a certain angle toward a clockwise direction with respect to the reference coordinate system.

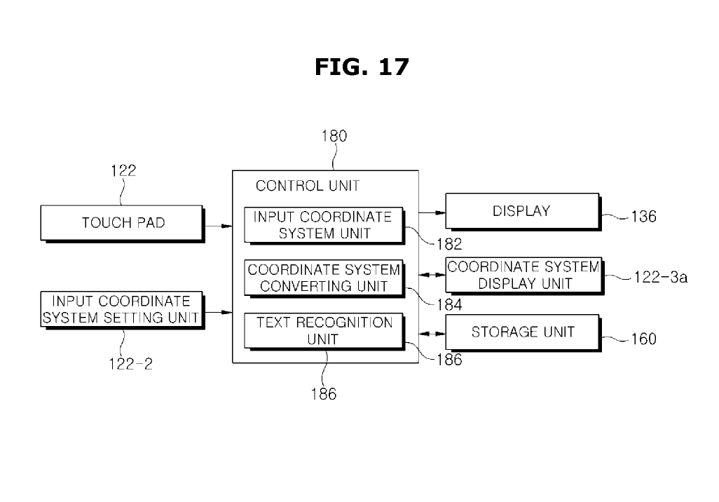

FIG. 17 is a block diagram showing a structure of the input apparatus in accordance with embodiments of the present disclosure.

Referring to FIG. 17, the input apparatus 10 in accordance with embodiments of the present disclosure includes the touch pad 122, the input coordinate system setting unit 122-2, the display 136, the coordinate system display unit 122-3a, the storage unit 160, and the control unit 180. The descriptions with respect to the touch pad 122, the input coordinate system setting unit 122-2, the display 136, and the storage unit 160 are identical to the descriptions provided on FIG. 5, and thus the overlapping descriptions will be omitted.

The coordinate system display unit 122-3a may be able to display an input coordinate system which is preset or set by a user. The control unit 180 may be able to provide the changed information by controlling the coordinate system display unit 122-3a, when the setting environment of the input coordinate system is changed through the coordinate system display unit 122-3a. A user may be able to visually confirm the information such as the direction of the input coordinate system on the basis of the displayed information of the coordinate system display unit 122-3a, and as a result, texts may be able to be input while provided with more accurate direction.

Next, a control method of the vehicle 100 in accordance with embodiments of the present disclosure will be described.

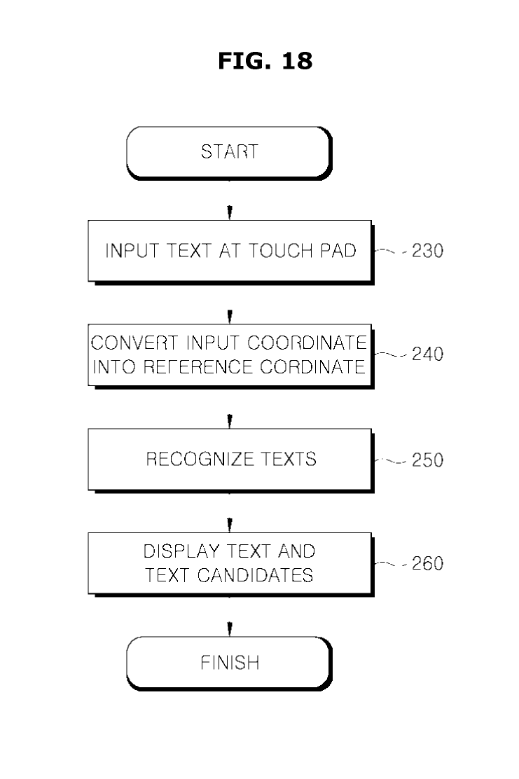

FIG. 18 is a drawing showing a flow chart of the control method of the vehicle 100 in accordance with embodiments of the present disclosure.

Referring to FIG. 18, the control method of the vehicle 100 in accordance with embodiments of the present disclosure includes a phase of being input with a text at a virtual input coordinate system that is set at the touch pad 122 (230), a phase of converting the input coordinate of the text being input at the input coordinate system into the reference coordinate of the preset reference coordinate system (240), a phase of recognizing the text through the reference coordinate (250), and a phase of displaying the recognized text and the text candidates of the text (260).

A user may be able to input a text through a method of inputting a drag touch signal at the touch domain 122-1 of the touch pad 122 (230). The drag touch signal according to one example may be input by use of a finger or a pen, but is not limited hereto. The touch domain 122-1 may be defined as the input coordinate system, and the input coordinate system may be provided earlier according to the environment of the vehicle. For example, the rotational angles of the input coordinate system provided in a case of the LHD vehicle or the RHD vehicle may be different, and hereinafter, the descriptions that overlap with respect to the previous descriptions will be omitted.

When texts are input at the touch pad 122, the input coordinate of the texts may be transmitted to the input coordinate system input unit 182 of the control unit 180. When the input coordinates of the texts is transmitted to the input coordinate system input unit 182, the input coordinate values may be input at the input coordinate system. When the input coordinate values are input at the input coordinate system, the coordinate system converting unit 184 may be able to convert the input coordinate values into the reference coordinate values at the preset reference coordinate system (240). When the input coordinate values are converted into the reference coordinate values, the input texts may be recognized by use of the converted reference coordinate values (250). With respect to the method of recognizing texts, a conventional text recognizing method may be employed, and during the process of text recognition, the pre-stored text data may be provided at the storage unit 160. When the text is recognized, the recognized text and the text candidates of the text may be disposed at the display 136 (260). In accordance with embodiments of the present disclosure, additional text candidates of the text may be displayed as well.

Next, a control method of the vehicle 100 in accordance with embodiments of the present disclosure will be described.

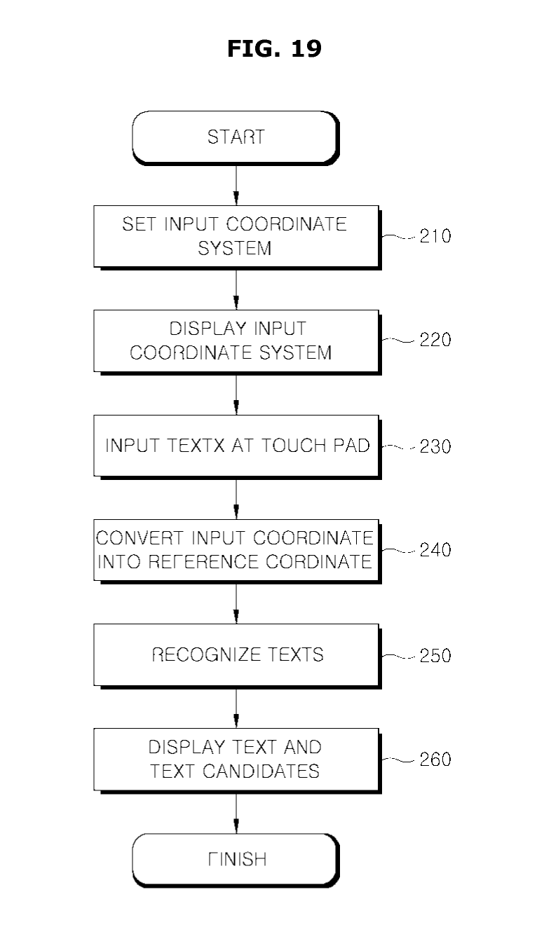

FIG. 19 is a drawing showing a flow chart of the control method of the vehicle 100 in accordance with embodiments of the present disclosure.

Referring to FIG. 19, the control method of the vehicle 100 in accordance with embodiments of the present disclosure includes a phase of setting a virtual input coordinate system at the touch pad 122a (210), a phase of displaying the set input coordinate system (220), a phase of being input with a text at the virtual input coordinate system at the touch pad 122a that is set at the touch pad 122 (230), a phase of converting the input coordinate of the text being input at the input coordinate system into the reference coordinate of the preset reference coordinate system (240), a phase of recognizing the text through the reference coordinate (250), and a phase of displaying the recognized text and the text candidates of the text (260). Hereinafter, the processes that overlap with the processes from FIG. 18 will be omitted, and the differences with respect to FIG. 18 will be mainly described.

In the phase of setting the virtual input coordinate system at the touch pad 122, the input coordinate system may be varied according to the setting of a user (210). According to one example, depending on the environment of the vehicle, the input coordinate system may be provided in the shape of an inclined manner by a particular angle with respect to the reference coordinate system. In a case as the above, according to the physical conditions of a user, the user may feel inconvenient with the input coordinate system provided earlier, and thus the use may be needed to freely set the input coordinate system.

Next, the phase of displaying the set input coordinate system may be executed (220). In the present phase, a user may be able to visually confirm the input coordinate system through the input coordinate system display unit 122-3a. According to the embodiments, a user may input texts while visually confirming the input coordinate system, and may be able to set the coordinate system while confirming the input coordinate system in real time.

As the above, the input apparatus 10, the vehicle 100 having the same, and the control method of the vehicle 100 are described. Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An input apparatus, comprising:
a touch pad configured to receive input;
an input coordinate system setting unit configured to set an input coordinate system at the touch pad so as to receive the input;
a coordinate system converting unit configured to convert an input coordinate value of the input at the input coordinate system into a reference coordinate value of a preset reference coordinate system;
a text recognition unit configured to recognize text based on the input by use of the converted reference coordinate value; and
a display configured to display the recognized text and one or more text candidates based on the recognized text.

2. The input apparatus of claim 1, wherein:
the input coordinate system is varied according to settings of a user.

3. The input apparatus of claim 1, wherein:
rotation angles of the input coordinate system are varied with respect to the reference coordinate system according to settings of a user.

4. The input apparatus of claim 1, wherein:
the input coordinate system is preset according to an environment of a vehicle.

5. The input apparatus of claim 1, wherein:
in a case of a left hand drive(LHD) vehicle, the input coordinate system is set while rotated toward a clockwise direction with respect to the reference coordinate system, and
in a case of a right hand drive(RHD) vehicle, the input coordinate system is set while rotated toward a counter-clockwise direction with respect to the reference coordinate system.

6. The input apparatus of claim 1, further comprising:
an input coordinate system display unit configured to display rotation angles of the input coordinate system with respect to the reference coordinate system.

7. The input apparatus of claim 1, wherein:
the one or more text candidates are selected by reflecting rotation angles of the input coordinate system with respect to the reference coordinate system.

8. The input apparatus of claim 7, wherein:
the display is further configured to display additional text candidates based on the recognized text, and
the additional text candidates are selected using a technique other than the reflecting of rotation angles of the input coordinate system with respect to the reference coordinate system.

9. A vehicle, comprising:
a touch pad configured to receive input;
an input coordinate system setting unit configured to set a input coordinate system at the touch pad so as to receive the input;
a coordinate system converting unit configured to convert an input coordinate value of the input at the input coordinate system into a reference coordinate value of a preset reference coordinate system;
a text recognition unit configured to recognize text based on the input by use of the converted reference coordinate value; and
a display configured to display the recognized text and one or more text candidates based on the recognized text.

10. The vehicle of claim 9, wherein:
the input coordinate system is varied according to settings of a user.

11. The vehicle of claim 9, wherein:
rotation angles of the input coordinate system are varied with respect to the reference coordinate system according to settings of a user.

12. The vehicle of claim 9, wherein:
the input coordinate system is preset according to an environment of a vehicle.

13. The vehicle of claim 9, wherein:
in a case of a left hand drive(LHD) vehicle, the input coordinate system is set while rotated toward a clockwise direction with respect to the reference coordinate system, and
in a case of a right hand drive(RHD) vehicle, the input coordinate system is set while rotated toward a counter-clockwise direction with respect to the reference coordinate system.

14. The vehicle of claim 9, further comprising:
an input coordinate system display unit configured to display rotation angles of the input coordinate system with respect to the reference coordinate system.

15. The vehicle of claim 9, wherein:
the one or more text candidates are selected by reflecting rotation angles of the input coordinate system with respect to the reference coordinate system.

16. The vehicle of claim 15, wherein:
the display is further configured to display additional text candidates based on the recognized text, and
the additional text candidates are selected using a technique other than the reflecting of rotation angles of the input coordinate system with respect to the reference coordinate system.

17. A control method of a vehicle, comprising:
receiving input at an input coordinate system that is set at a touch pad;
converting an input coordinate value of the input at the input coordinate system into a reference coordinate value of a preset reference coordinate system;
recognizing text based on the input by use of the converted reference coordinate value; and
displaying the recognized text and one or more text candidates based on the recognized text.

18. The control method of the vehicle of claim 17, further comprising:
controlling a setting of the input coordinate system at the touch pad.

19. The control method of the vehicle of claim 18, wherein:
the input coordinate system is varied according to settings of a user.

20. The control method of the vehicle of claim 18, wherein:
the input coordinate system is preset according to an environment of a vehicle.

21. The control method of the vehicle of claim 17, further comprising:
selecting the one or more text candidates by reflecting rotation angles of the input coordinate system with respect to the reference coordinate system.

22. The control method of the vehicle of claim 21, further comprising:
selecting additional text candidates using a technique other than the reflecting of rotation angles of the input coordinate system with respect to the reference coordinate system; and
displaying the additional text candidates.
